(19) United States
(12) Patent Application Publication
(10) Pub. No.: US 2005/0255905 A1
(43) Pub. Date: Nov. 17, 2005

(54) Electronic lottery game card

(76) Inventors: Dana Kipland Duke, Jefferson, GA (US); Charles W. Kline, Camp Hill, PA (US)

Correspondence Address: CARLTON FIELDS, PA, 1201 WEST PEACHTREE STREET, 3000 ONE ATLANTIC CENTER, ATLANTA, GA, 30309, US

(21) Appl. No.: 11/130,776

(22) Filed: May 17, 2005

Related U.S. Application Data
(60) Provisional application No. 60/571,783, filed on May 17, 2004.

(51) Int. Cl. G06F 19/00; G06F 17/00

(52) U.S. Cl. 463/17

(57) ABSTRACT

An electronic lottery game card having a body with a front face and a back face, and the electronic game card is powered by a battery with a plurality of viewing windows in the front face. The viewing windows can display items such as a simulated wheel spinning. There is a power switch in the front face for activating games. A player can activate the game card to play a lottery game with the viewing windows, and the electronic game card will automatically shut itself off when there is inactivity after a fixed period.

### CROSS-REFERENCE TO RELATED APPLICATION

This application claims the benefit of U.S. Provisional Patent Application No. 60/571,783, filed on May 17, 2004, the entirety of which is hereby incorporated herein by this reference.

### BACKGROUND OF THE INVENTION

1. Field of the Invention

The present invention relates to game cards, and more specifically, relates to electronic game cards for use as instant lottery game tickets.

2. Description of the Related Art

The use of electronic game or promotional cards or game cards is known. An example of such a game card is disclosed in International Publication Number WO 03/0080507 A1 entitled Game Device. The game card shown in this publication uses a liquid crystal diode (LCD) screen to display a play area formed of three (3) windows defined within a front face on the game card. The game card has a microprocessor which is programmed to allow the customer to receive 80 plays per game card. The game is activated by removing a battery tag located on a back face of the card thus allowing the battery to energize the card.

Each play of the card begins when the game player pushes a “play” button located on the front face of the card. If any of the numbers revealed in the three windows on the front face of the card match the combination of numbers specified in a predetermined prize grid, the prize grid being programmed in known fashion for lottery games, the customer wins the corresponding prize amount.

During game play of the card the game player may accumulate “points” ranging from one to one thousand per card. For example, each game point may be worth twenty-five cents ($0.25), or whatever value is desired. Each game card may also contain a minimum number of prize points, for example 20 points being worth $5.00 in the previous example, and may also be programmed to have a maximum prize value, for example a value of 1,200 points equating to $300.00 where the points are worth a $0.25 each.

The use of an electronic game card as an instant lottery game “ticket” is unknown, however, due to the specific requirements of lotteries with regard to the predetermination of a prize structure associated with the game, as well as the security, validation and redemption procedures and system requirements of lotteries, as known to those skilled in the art.

What is needed, therefore, is an electronic game card adapted for use by lotteries as an electronic instant lottery game “ticket,” as it were, capable of multiple plays, with a predetermined prize structure, and able to be validated and redeemed through existing lottery systems. It is thus to such game card that the present invention is primarily directed.

### SUMMARY OF THE INVENTION

Briefly described, in one embodiment, the present invention comprises an electronic game card adapted for use by lotteries as an electronic version of a lottery game “ticket” capable of multiple plays. The game card is provided with a predetermined prize structure, and is adapted to be validated and redeemed through existing lottery systems. The game cards are labelled in such a manner so as to be compatible with known lottery instant or scratch off game ticket validation and redemption systems.

In one embodiment, the invention is a lottery game card with a card having a first face and a second face, a battery for powering the game card placed in the card between the first face and the second face, a plurality of viewing windows on the first face for displaying the lottery game, and a switch button on the card, wherein the switch button activates the lottery game.

In another embodiment, the invention is a method for manufacturing a pack of electronic game cards. The method includes scanning a bar code from a label tape, issuing a feed command to a storage bin according to the bar code, feeding a game card from the storage bin onto a conveyor, applying a face label to the game card, delivering the game card to a batch stacker, accumulating a plurality of the game cards into a pack, placing an activation card onto the pack, and wrapping the pack of the game cards with the activation card.

In yet another embodiment, the invention is a method for manufacturing a pack of electronic game cards. The method includes creating a graphics label for a game card, the game card having a front and a back, applying a front face graphics label to the front of the game card, creating a unique rear face label for the back of the game card that includes a unique validation number for the game card, applying a label over the game card validation number, applying a rear face label to the back of the game card, providing an instruction card for the game card prior to packaging each game card, packaging the game card, assembling a plurality of the packaged game cards into a game card pack, providing an activation card for the game card pack, and packaging the game card pack.

Other aspects and features of the invention will become apparent after review of the hereinafter set forth in the following Brief Description of the Drawings, Detailed Description of the Invention, and the claims.

### DETAILED DESCRIPTION OF THE DRAWINGS

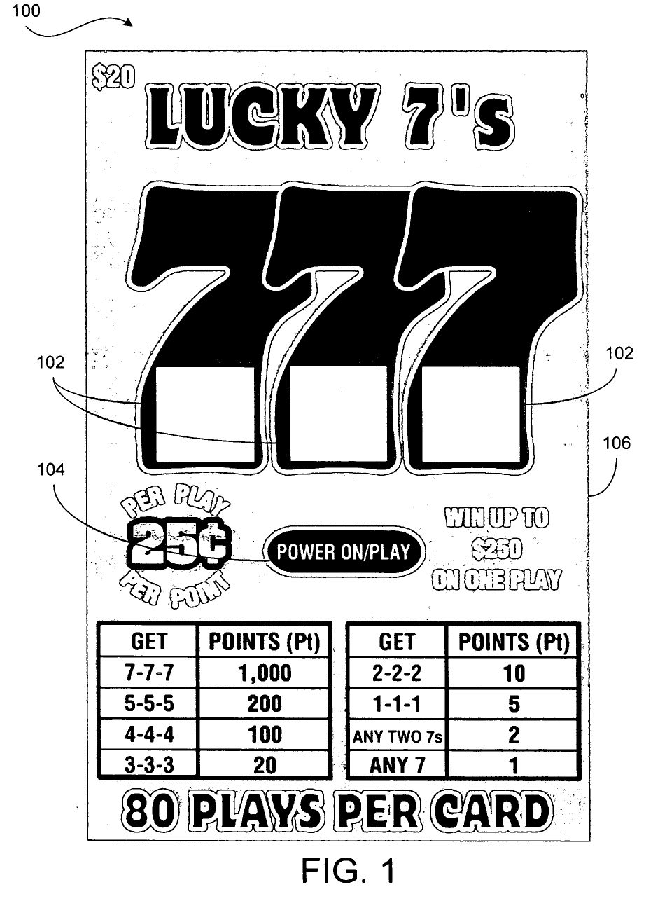

FIG. 1 illustrates one game card according to one embodiment of the invention.

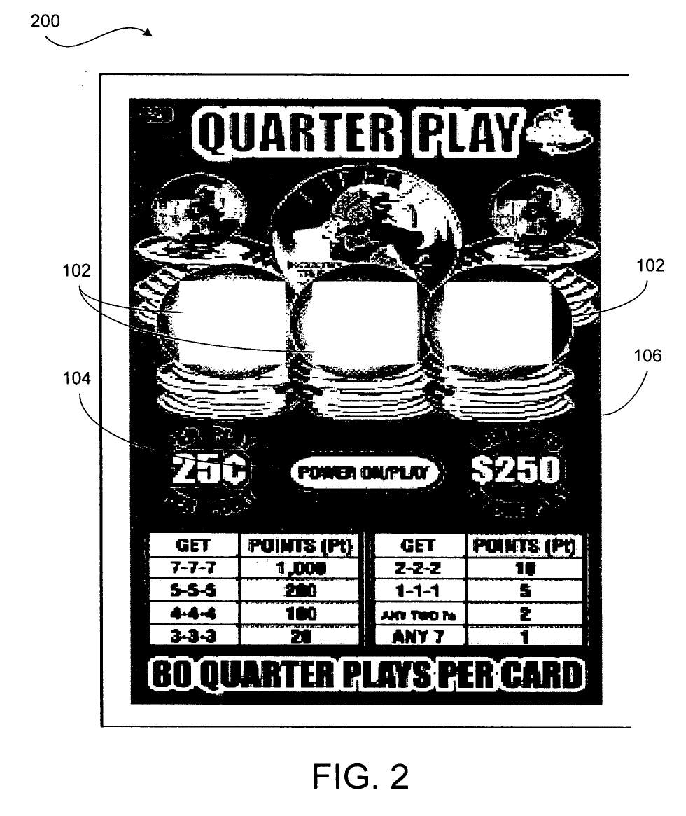

FIG. 2 illustrates one game card according to an alternate embodiment of the invention.

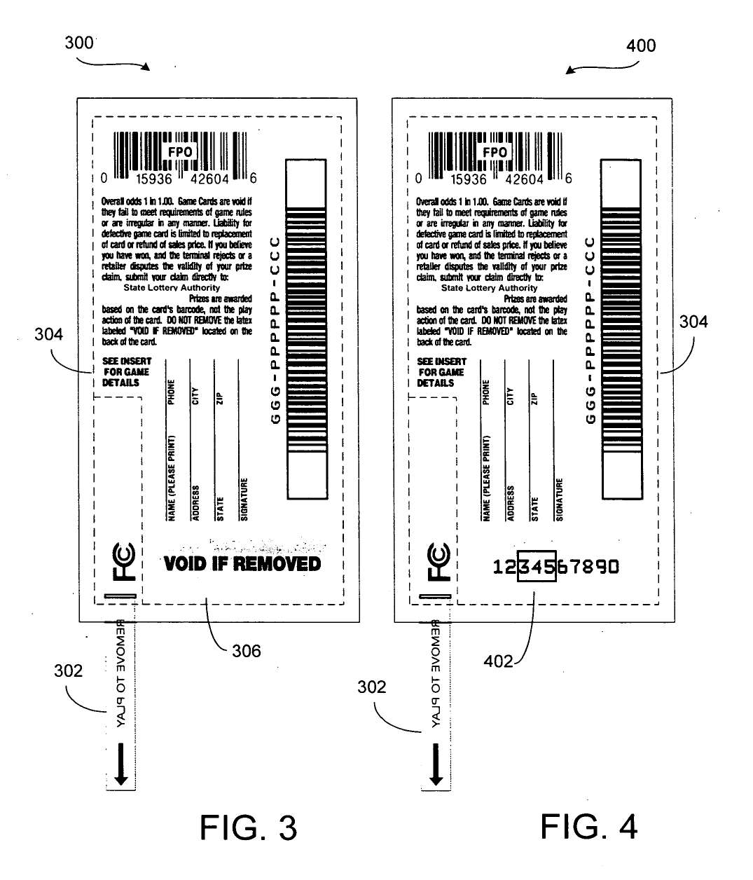

FIGS. 3-4 illustrate game cards with their battery tags removed.

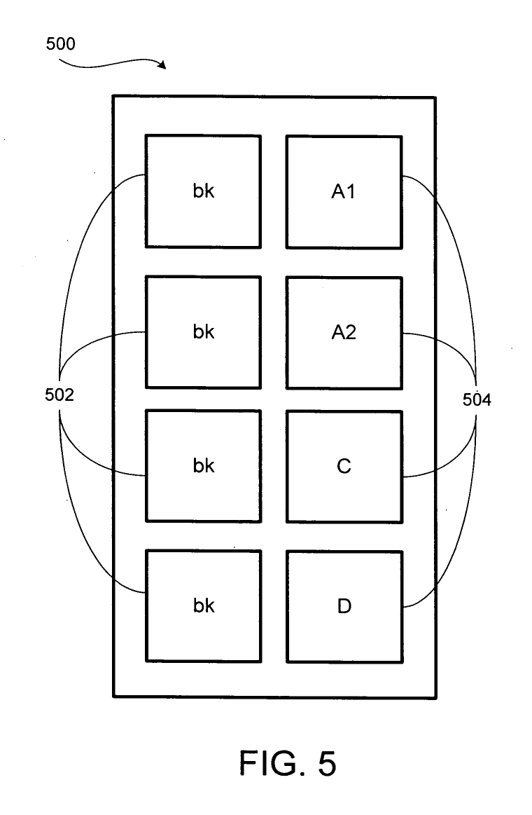

FIG. 5 illustrates a back label for a game card.

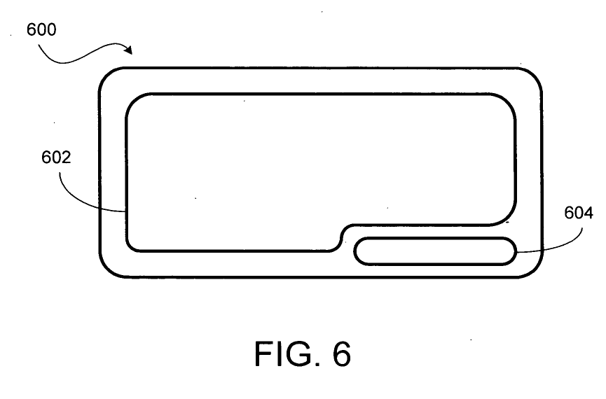

FIG. 6 illustrates an alternative placement of a power tag on a game card.

### DETAILED DESCRIPTION OF THE INVENTION

The invention is directed to an electronic game card and the manufacturing process thereof. The electronic lottery game card has a body with a front face and a back face. The electronic game card is powered by a battery with a plurality of viewing windows in the front face. The viewing windows display a simulated wheel spinning. There is a power switch in the front face for activating games. The electronic game card will automatically shut itself off when there is inactivity after a fixed period.

FIG. 1 illustrates one embodiment of the invention, the game card 100 may be sized to be, as way of example and not limited to, 85 mm×54 mm×approximately 3 mm with a circumferential lip or edge formed for receipt of a front label or marking on a face of the game card 100. The game card 100 may be constructed of plastic or other suitable material with sealed edges. Three spaced liquid crystal diode (LCD) display screens 102 and corresponding view windows are located on a front face of the game card 100. The game card 100 has a power on or play button 104. FIG. 2 is another exemplary embodiment of the invention.

The cards 100 may be powered by a battery, for example an alkaline/manganese button battery, or other batteries, as desired. It is anticipated that if an alkaline/manganese battery is used, that the battery will have a shelf life of approximately one year prior to battery activation and have a product life after activation of approximately six months. The game card 100 is activated by removing a battery tag 302 as illustrated in FIGS. 3 and 4. The battery may be placed anywhere in the game card and in one exemplary embodiment the center of the battery tag 302 is located approximately 2 mm from the edge of the bottom of the card, and the battery tag may have wording thereon such as “Remove to Play.”

The center of the play button 104 can be placed anywhere on the game card 100. In one embodiment, the play button 104 is located below the LCD windows 102 in the front face of the card as shown in FIGS. 1 and 2. In one embodiment, the play button 104 functions as a power-on switch for the game card 100, as well as turning the card's power supply on for game play once the battery has been activated. The card 100 has an internal timer and may be programmed to shut down or power off after a predetermined time period, for example 20 seconds of inactivity, in order to conserve the power. When the card 100 is shut down for inactivity, the card 100 may preserve the play. When the play button 104 is pressed once again, the game will restart at the point where play was interrupted. Alternatively, the card 100 may reset each time the play button 104 is pressed. In an alternative embodiment, the game card 100 may have two buttons (not shown), one play button and one switch button.

As shown in FIGS. 1 and 2, it is anticipated that a label will be affixed to the front face of the game card, the label will provide an appearance of the game card similar to that of the known types of non-electronic, i.e., paper, instant win or scratch off lottery game tickets, although such a label is not required. Additionally, the front face of the game card may be labelled by directly printing a label thereon, as desired.

The game card label, if so provided, may be placed within the area formed by the raised or protruding lip encircling the front face of the game card. The label will preferably list the desired game play information thereon as specified by the artwork and in conventional fashion. The label will also have three die cut holes to accommodate the three LCD display windows 102 or screens described above.

A label 304 is affixed to the back or rear face of the game card as shown in FIGS. 3 and 4. This label 304 may also be placed within a raised or protruding lip, if so provided, encircling the back of the card defining a label receiving area. The rear label will contain all play information as specified by the artwork, as well as a UPC barcode for the game, as specified by the artwork, and will in all aspects contain the required validation and authentication information required by lotteries, and as used for the known types of scratch off lottery and promotional game tickets.

Accordingly, there will also be a unique barcode representation of the game, pack, card and validation data appearing on the back of the card, as specified by the artwork. For example, the barcode may contain 22 digits as follows:
GGGPPPPPPCCCVVVVVVVVVV
where “GGG” equates to a three digit game number, and “PPPPPP” to a six digit pack number. “CCC” represents a three digit card number, and 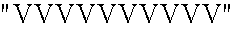
   will represent an encrypted eight digit validation number/prize code and an accompanying two digit check code.

The single barcode may thus be a standard interleaved 2-of-5 symbology utilizing standard start and stop characters, where each barcode character may encode 2 decimal digits and measures approximately 0.4″ high and 0.183″ in length. The entire barcode with start and stop characters may measure 2.11″ in length, and the barcode may be provided with “quiet” zones on each end measuring a minimum of 0.18″ in length. The barcode may start with a narrow bar, a narrow space, a narrow bar, a narrow space (start character) and may end with a wide bar, a narrow space and a narrow bar (stop character), as desired. The distance from the middle of the barcode to the bottom edge of the card will preferably be 0.35″.

Appearing above the barcode in human readable form may be a game, a pack and a card number (GGG-PPPPPP-CCC), respectively. The human readable number should preferably be printed approximately 0.1″ above the top of the barcode, and pack numbers may start at 100001 (beginning with Pool 1), or with any other desired numbering scheme. Game card numbers may thus start at 000 and end at 014 within each pack, or as otherwise desired based on pack size.

There may also be a unique concealed 10-digit validation code 402, shown in FIG. 4, appearing on the back of the card, as specified by the artwork. The validation code will preferably be concealed with latex and marked with a “VOID IF REMOVED” label 306, shown in FIG. 3.

The card numbering will preferably be formulated according to known types of lottery ticket numbering schemes. The format of the validation code will preferably be: 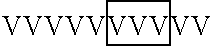
where 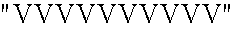
   represents an encrypted eight digit validation number/prize code and an accompanying two digit check code. Three consecutive digits of this 10 digit number referenced will be boxed in an apparently random manner, giving 6 possible positions for the box (the last 2 digits cannot be boxed).

Each game card may contain any desired number of wining plays, for example there may be between nine (9) and forty (40) winning plays on each such card. Consecutive plays on a card will preferably not have identical play data, and consecutive cards within a pack will preferably not have identical play data.

The play symbols will appear randomly at all three LCD windows 102 or display positions for both winning and non-winning cards. A simulated wheel spin will appear in each window 102 as the numbers are revealed per sample. The numbers are preferably revealed from left to right.

Each win is associated with a number of points. For wins of less than 100 points, the message “Win” followed by the number of points won for that play will flash on the card. For example, if the winning combination was “222”, the following message will flash: “Win 10”. This message indicates you have won “10” points. For wins of 100 points or more, the letter “W” will appear in the first window followed by the number of points. For example, if the winning combination was “555” the following message will flash: “W 200”, equating to a win of 200 points.

The points awarded in each of the number of plays provided by the game card are accumulated and displayed on the LCD screen after each play. The points are identified in window one (1) using the symbol “Pt”. The plays remaining on each card are displayed on the LCD screen after each play. The plays are identified in windows one (1) and two (2) as PLAY.

The label for the back of each card which will include all of the specified unique information for the card including a 22 digit barcode, as discussed above, a human readable pack number or identifier, a card number, a validation code, and other non-unique information which will include location for name, address, and signature, UPC code and game rules.

The validation code will include a boxed number set which will be used for card validation in the redemption process. In order to prevent tampering or “pick out” of the cards prior to retail, the validation number will be hidden using a pressure sensitive label that has a scratch off surface. The pressure sensitive scratch off label will be constructed such that the label material is a clear film which has scratch off latex printed on it. The film will incorporate a permanent adhesive that will adhere it to the back label. When the scratch off is removed from the film, the clear film will remain over the validation number.

The result of this operation will be a scratch off validation field on the card that will function identically to how a validation code is revealed on a paper instant lottery ticket.

The label for the back of the electronic game card, designated as “bk” in FIG. 5, will be applied to the back of the card. The remaining label, bearing the corresponding value designator if manual sorting has been employed on the game cards, will not be applied to the card and will be destroyed.

Additionally, a designator 504, as shown in FIG. 5, may be printed along side the actual back label even in an automated mode just for ease of human recognition or to reconcile an issue in the start or stop of the machine, as shown in FIG. 5. Either way, however, the barcode on the ticket will be read and using a book ticket information acquired from the barcode the appropriate electronic game card value can be looked up in a corresponding table. The designator is not a part of the barcode, but the barcode will always lead the lottery vendor to the appropriate designator by way of a look up table created by programming. It is possible to use the exact file used to print the label to acquire the card designator for the machine to select the right card from the right feeder.

Each game card will be packaged with an instructional card (not shown) included in the individually wrapped game card package. The instructional card will be placed on top of the game card after the game card has been fed into a wrapping machine, but before the game card is over wrapped during the packaging process. The result will be that each game card will have an instructional card included inside the package. Game card packs may be over wrapped using a bandoliered flow wrap in which each card is over wrapped using a clear poly film applied in a conventional hot “fin seal” wrapping operation.

Each pack of game cards will also receive an activation card in the exact same process as do traditional scratch off lottery tickets. The activation card will be applied to the top of the stack of 15 cards, or whatever number of cards forms a pack of cards, prior to shrink wrapping the game pack. The activation card will be packed in such a way that the barcode is readable by a suitable lottery system terminal able to read and process the data on the game card label and/or the activation label.

### Description of Electronic Game Card Labeling Process

In an automated embodiment of the game card labeling process, there will be three discrete operations or steps involved in labeling the Electronic Game Cards, which are:
1.) front graphic label application to all game cards;
2.) collation of the game cards, back label application and formation of game card packs; and
3.) packaging the game cards, which may include by way of example and not of limitation, over wrapping the game cards into a “bandolier” format, z folding the bandolier, and shrink wrapping the pack together.

The front labels will be machine applied to the front of the card using a conventional label application equipment. The process for this operation will be as follows:
1.) game cards are fed from a friction feeder onto a conveyor;
2.) a downstream label applicator affixes a front label to a front face of the game card;
3.) a quality control check to ensure that the front label is firmly attached or adhered to the game card;
4.) the labeled game cards are then placed back into their individual game card packages for further processing.

The card collation process is driven by the information found on the label tape bearing the game card rear face label. The rear face label will be pre-printed and made available in its completed form with a suitable lottery barcode imaged thereon as well as the appropriate validation code. A latex scratch off security layer will have been printed over the validation number as a part of the printing process for the rear face label.

The rear face label will be machine applied to the card using a known type of a label application machine, such as those manufactured by Label-Aire, Inc.

The game card's power tag can be modified and located on the rear face or back label of the game card. FIG. 6 illustrates a rear face 600 with a back label 602 and a power tag 604.

The collation process will call for the appropriate number of feed pockets, such as Universal Collator Systems™ manufactured by Streamfeeder LLC, which will all be linked electronically to a control processor, for example a computer, used to operate a feed on demand processing and/or collation systems.

The game card collation process for placement of the rear face label thereon will be performed as follows:
1.) a barcode scanner will read the barcode printed on the label tape;
2.) a controller will issue a feed command to the correct feeder/game card storage bin based on the detected barcode information;
3.) the game card is fed onto an intelligent conveyor from its feed bin;
4.) the game card is then transported to a label applicator positioned along and with respect to the conveyor and the rear face label is applied to the game card;
5.) the game card is delivered into a batch (game pack) stacker;
6.) the batch stacker accumulates a “pack” quantity of the game cards;
7.) an activation card is separately printed beforehand and is placed with the accumulated game cards/game card pack; and
8.) the game card pack is banded for handling prior to being passed off to a downstream game card pack wrapping process.

Once collated, the game cards may be over wrapped in a conventional fin-pack or seal type of a packaging machine or system. The game cards will be over wrapped and delivered in continuous fashion to the packaging machine such that they are attached together within a tube of the packaging film, which film tube is perforated at the seams at each respective end of the packaged game cards held within the film tube, as known to those skilled in the art, in a “bandolier” fashion.

In a second automated or manually performed embodiment of the labeling process for the electronic game cards, the lottery vendor may perform the following actions:
1. create a graphics label for each game card;
2. apply a front face graphics label to the front of each such card;
3. create detailed collation plan for the game cards;
4. create a unique rear face label for the back of each game card which includes a unique validation number for that card, and which number is covered by a scratch off latex layer or coating;
5. apply a label with, or a scratch off latex layer or coating over the game card validation number;
6. collate a desired number of the game cards into a pack and apply each rear face label to the back of the respective game cards in the collation process;
7. provide an instruction card for each game card prior to packaging the individual game cards;
8. wrap or package the individual game cards as desired;
9. assemble the individually packaged game cards into a game card pack;
10. provide an activation card for each game card pack;
11. wrap or package each game card pack;
12. box the game card packs and apply box label information thereto; and
13. ship to the purchasing lottery or entity.

The game cards will be delivered to the packaging line or process with all internal programming complete, and will also arrive segregated by winning value. The game cards will thereafter be packaged in separate trays per winning value. A detailed description of each of the actions listed above follows.

Once the label art is approved the labels will be printed and die cut, as appropriate. The graphics of the label will preferably be printed to match the respective lotteries' approved artwork, and each front face label will have 3 die cut windows defined therein which will be die cut to match the LCD window positions of the electronic game card.

Where labels are to be applied by hand, they will be applied to each card so that the label will be aligned with the edges of the card and with the LCD windows on the card. In the event of a large production run of game cards, an automated label application process may be employed, using conventional label affixing equipment and a feeding base.

Where a manual sort or collation process is used to assemble game card packs, each set of electronic game cards will require collation into a specific set in order to guarantee the lottery the proper prize structure. It is anticipated that a collation plan will be generated utilizing the approved prize structure. For example, and not by way of limitation, where a game card run of 20,000 game cards is used, one exemplary collation plan may result in 1333 records of 16 fields each. The 16 fields will indicate pack number, and the appropriate card designator for each position in the pack.

Some example card designations may be as follows:
A1
A2
A3
A4
B
C
D
E

Some example records of the collation plan may thus be as follows:

TABLE 1

| Pk# | C1 | C2 | C3 | C4 | C5 | C6 | C7 | C8 | C9 | C10 | C11 | C12 | C13 | C14 | C15 |
|---|---|---|---|---|---|---|---|---|---|---|---|---|---|---|---|
| 0001 | A1 | A1 | A2 | A4 | A3 | B | A2 | A3 | C | A4 | A1 | D | A1 | A4 | A3 |
| 0002 | B | A3 | A4 | C | A1 | A1 | A4 | A2 | B | C | A4 | A3 | A2 | A3 | A4 |
| 0003 | A3 | A4 | A1 | A3 | A2 | D | C | B | A1 | A2 | A3 | A4 | A2 | A4 | A1 |
| 0004 | C | A3 | A4 | B | A4 | A3 | A1 | A2 | C | D | A1 | A1 | E | A3 | B |

This example collation plan is strictly an example of the appearance and content of the plan and has no prize structure influence at all at this point. In this example, the “pk#” column indicates pack number. All columns C1 through C15 indicate which category of card occurs in that position of the pack. A formal, or final, collation plan will be generated using the same programming practices and audit procedures incorporated in paper lottery ticket programming.

Next, a unique label will be created for the rear face of each game card, which label will include a validation number which must be covered by latex. Each rear face label will include all of the specified unique “ticket” information for that game card, including a 22 digit barcode, as well as a human readable pack and ticket number, a validation code, and other non unique information which will include location for name, address, and signature, UPC, game rules, and the like, as known to those skilled in the art.

The labels will be printed prior to the collation process so that the labels will be available for application to each game card as it is selected in the collation process. The labels will be printed such that there will be an area remaining on the label tape or backing that will bear a value designation for that given label, as illustrated in FIG. 5.

Each label for the rear face or back of the electronic game cards will have a unique validation code printed thereon. The validation code will be printed simultaneously with all the other unique information on the back of the label. The validation code will include a boxed number set which will be used for card validation in the redemption process. In order to prevent tampering or “pick out” of the cards prior to retail, the validation number will be hidden using a pressure sensitive label that has a scratch off surface.

The pressure sensitive scratch off label will be constructed such that the label material is a clear film which has scratch off latex printed on it. The film will incorporate a permanent adhesive that will adhere it to the back label. When the scratch off label is removed from the film, the clear film will remain over the validation number. The result of this operation will be a scratch off validation field on the card that will function identically to how a validation code is revealed on paper instant lottery ticket.

Where the process of collating the game cards is performed manually, where for example a small production run of game cards has occurred, a tray of each value of game card, i.e. cards A1, A2, A3, A4, B, C, D, and E, will be located in convenient racks. Each game card will thereafter be pulled from its holding or storage rack in the exact order prescribed by the programmed collation plan.

Each time a game card rear face label is pulled it will be applied to the rear face of the electronic game card, insuring by the UPC or bar code and the label designator that the correct label is being applied to the correct card. The label designator, which is not a part of the label applied to the game card, and as shown in FIG. 5, provides a margin of safety to ensure that the proper code for the value of the card to which that label is applied is satisfied.

The label for the back of the electronic game card, designated as “bk” in FIG. 5, is applied to the rear face of the card. The remaining label, the value designator, will not be applied to the card and will be destroyed. The purpose of this is so that the person applying the label can ensure that they have selected the proper electronic game card for the label being applied. This is used to ensure that the correct label is on the correct value card so that validation will work correctly.

Each game card will be packaged with an instruction card included in the individually wrapped game card package. The design on the front of the instructional insert may be identical to the design on the front of the game card, as desired. The back of the insert may contain play instructions, claim information, rules and other information, as desired. The instruction card will be placed on top of the game card after the card has been fed into a wrapping machine, for example, but before the game card is individually packaged. The result will be that each card will have the instructional card included inside the game card package.

Once the instructional card has been placed with the game card, then, each card may be individually packaged, for example by being over wrapped using a clear polyethylene film that will be applied in a “fin seal” wrapping operation. The set of game cards forming the card pack will be delivered in a continuous strip or tube of packaging film formed about the game cards, commonly referred to as being “bandoliered” in the packaging industry. There will be a perforation in the film tube/strip between each card for ease of removal from the bandoliered strip at the retail location.

As an illustrative example, an over wrapped game card pack of 15 cards would be approximately 45 inches long when delivered from the packaging machine. The strip would then be folded into a Z-shaped folded stack of 15 game cards. This folded stack of game cards will then be prepared for shrink wrapping or other forms of packaging, as desired.

Each pack of game cards will then be provided with an activation card in the exact same process as is a book of scratch off or instant win lottery game tickets. The activation card will be applied to the top of the pack of game cards prior to shrink wrapping the pack in final packaging. The packs of game cards may then be boxed in the same or similar fashion as is employed for lottery ticket books. Extra precautions may be needed to ensure that the electronic game cards are properly protected for shipment. Thereafter, each box will be labeled with the lottery approved label format. Of note, all operations prior to boxing the game card packs will be performed identically to those used for standard scratch off lottery game tickets.

While the invention has been particularly shown and described with reference to one embodiment thereof, it will be understood by those skilled in the art that various changes in form and detail may be made without departing from the spirit and scope of the present invention as set forth in the following claims. Furthermore, although elements of the invention may be described or claimed in the singular, the plural is contemplated unless limitation to the singular is explicitly stated.

1. An electronic game card for playing a lottery game, comprising:
a card having a first face and a second face;
a power source held in the card between the first face and the second face;
a plurality of viewing windows on the first face for displaying the lottery game; and
a switch on the card, wherein the switch button activates the lottery game.

2. The electronic game card of claim 1, further comprising a battery tag on the card, wherein removing the battery tag powers the game card.

3. The electronic game card of claim 1, wherein the power source is a battery.

4. The electronic game card of claim 1, wherein each of the plurality of viewing windows are liquid crystal diode (LCD) display screens.

5. The electronic game card of claim 1, wherein the card is plastic.

6. The electronic game card of claim 1, wherein the card has sealed edges.

7. The electronic game card of claim 1, further comprising a label placed on the first face, wherein the label provides an appearance of a lottery game ticket.

8. The electronic game card of claim 1, further comprising a raised lip encircling the first face.

9. The electronic game card of claim 1, further comprising a bar code.

10. The electronic game card of claim 1, further comprising a timer, wherein the game card automatically shuts down after the timer expires.

11. The electronic game card of claim 1, further comprising a front label printed on the first face.

12. The electronic game card of claim 1, wherein a simulated wheel spin appears in each viewing window.

13. A method for manufacturing a pack of electronic game cards, comprising the steps for:
scanning a bar code from a label tape;
issuing a feed command to a storage bin according to the bar code;
feeding a game card from the storage bin;
applying a face label to the game card;
delivering the game card to a batch stacker;
accumulating a plurality of the game cards into a pack;
placing an activation card onto the pack; and
wrapping the pack of the game cards with the activation card.

14. The method for manufacturing a pack of electronic game cards of claim 13, further comprising the step for applying a graphics label to the face label.

15. The method for manufacturing a pack of electronic game cards of claim 13, wherein the feeding step further comprises the step for feeding the game card from the storage bin onto a conveyor.

16. The method for manufacturing a pack of electronic game cards of claim 13, further comprising the steps for:
creating a rear label that includes a validation number; and
applying the rear label to the game card.

17. A method for manufacturing a pack of electronic game cards, comprising the steps for:
creating a graphics label for a game card, the game card having a front and a back;
applying a front face graphics label to the front of the game card;
creating a unique rear face label for the back of the game card that includes a unique validation number for the game card;
applying a label over the game card validation number;
applying a rear face label to the back of the game card;
providing an instruction card for the game card prior to packaging each game card;
packaging the game card;
assembling a plurality of the packaged game cards into a game card pack;
providing an activation card for the game card pack; and
packaging the game card pack.

18. The method for manufacturing a pack of electronic game cards of claim 17, further comprising the steps of boxing the game card pack and applying a box label information.

19. The method for manufacturing a pack of electronic game cards of claim 17, further comprising the step of creating detailed collation plan for the game card and collating a desired number of the game card into a pack.

20. An electronic game card for playing a lottery game, comprising:
card means having a first face and a second face;
means for powering the game card placed in the card between the first face and the second face;
means for viewing on the first face for displaying the lottery game; and
means for activating the lottery game.
